(19) United States
(12) Patent Application Publication
(10) Pub. No.: US 2005/0165662 A1
(43) Pub. Date: Jul. 28, 2005

(54) Storage medium having electronic circuits, information management method and information processing system using said storage medium

(76) Inventors: Takashi Shigetomi, Miyagi-ken (JP); Tetsuo Saito, Miyagi-ken (JP); Eiji Yokota, Miyagi-ken (JP)

Correspondence Address: MERCHANT & GOULD PC, P.O. BOX 2903, MINNEAPOLIS, MN, 55402-0903, US

(21) Appl. No.: 09/749,100

(22) Filed: Dec. 27, 2000

(30) Foreign Application Priority Data
Dec. 28, 1999 (JP) 11-375143

(51) Int. Cl. G06F 17/60

(52) U.S. Cl. 705/27

(57) ABSTRACT

A storage medium having electronic circuits which contains programs for automatic startup of a system by insertion or installation of the storage medium having electronic circuits, and totally achieves commercial display of various services, internet services such as contract procedure, purchase of goods and guide and retrieval, and user information management, an information management method and in an information processing system using such a storage medium. The invention provides an information management method in an information processing system including a network capable of dealing with information such as images, music, voice and documents in a large volume at high speeds, comprising the steps of, when connecting a removable storage medium having a storage section including a program storage area storing programs and an information storage area storing information, and an electronic circuit section mounting electronic circuits processing information, to a device on the network; selectively displaying header thumb-nail images corresponding to commercial information such as images, music, voice and documents stored by the storage medium in the information storage area thereof by operating programs stored in the storage medium in the program storage area thereof by cooperation of the device and the electronic circuits; and calling and displaying of corresponding commercial information, and/or purchase of information corresponding to the commercial information, and/or purchase of information corresponding to the commercial information, and/or connection to, or registration of, a service provider on the network corresponding to the commercial information, in accordance with selection and instruction of thumb-nail images desired by the operator.

### FIELD OF THE INVENTION

The present invention relates to a storage medium having electronic circuits, and an information management method and an information processing system using such a storage medium. More particularly, the invention relates to a storage medium having electronic circuits which provides, by insertion or installation of an intelligent disk, into a storage device, automatic startup of a system, commercial display of various services, services such as contract procedure, purchase of commercial products, and guidance retrieval via internet, total information management for users, and an information management method and an information processing system using such a storage medium.

### BACKGROUND OF THE INVENTION

Information exchange, supply of services through internet and e-commerce are now becoming more active than ever, and there are available services permitting connection to internet by a single touch with a menu.

On the other hand, there is provided a system of information management for user employing a storage medium such as a digital album system, as an information processing system, in which image data taken with a digital camera are sequentially assigned identifiers and stored in a disk.

However, the provided functions, as described above, are for simplifying operations for the user to receive a desired service. A commercial function where a user can recognize contents of service without connecting to internet is not provided. As a result, the service of connecting to internet and the information management by the user using a storage medium have conventionally been considered as being quite different from each other, and unification of these processes has not as yet been tried.

### SUMMARY OF THE INVENTION

The present invention provides a storage medium having electronic circuits which totally achieve services of permitting automatic startup of a system by insertion or installation of the storage medium, commercial display of various services, and services such as contracting procedure, purchase of commercial products and retrieval of guidance, on the one hand, and user's information management, on the other hand, and an information management method and an information processing system using such a storage medium.

To achieve the aforementioned object, the invention provides an information management method in an information processing system including a network capable of dealing with information such as images, music, voice and documents in large volumes at high speeds, comprising the steps of, when connecting to a removable storage medium having a storage section including a program storage area storing programs and an information storage area storing information, and an electronic circuit section mounting electronic circuits processing information, to a device on a network; selectively displaying a header thumb-nail image corresponding to commercial information such as images, music, voice and document stored in the storage medium in the information storage area thereof by operating a program stored in the storage medium in the program storage area thereof by cooperation of the device and the electronic circuits; and calling and displaying of corresponding commercial information, and/or purchase of information corresponding to the commercial information, and/or connection to, or registration of, a service provider on the network corresponding to the commercial information, in accordance with selection and instruction of a thumb-nail image desired by the operator.

In the aforementioned information management method, the method comprises, when purchasing information corresponding to the commercial information, downloading the purchased information into a information storage area of the storage medium, or when processing a commodity purchase procedure of an information to be purchased, and when downloading the purchased information into the information storage area of the storage medium, registering a header thumb-nail image corresponding to the downloaded information in the information storage area of the storage medium. The aforementioned method comprises, when purchasing information corresponding to the commercial information, downloading the purchased information into the information storage area of the storage medium, or permitting a commodity purchase procedure of the purchased information, and when downloading the purchased information in the information storage area of the storage medium, registering the header thumb-nail image corresponding to the downloaded information in the information storage area of the storage medium. When connecting to the service provider or registration thereof corresponding to the commercial information, the method comprises downloading the commercial information of the service provider into the information storage area of the storage medium, and registering a header thumb-nail image corresponding to the commercial information in the information storage area of the storage medium. Also the above-mentioned method comprises the steps of further storing information prepared by the operator such as images, music, voice and documents in the information storage area of the storage medium, selectively displaying header thumb-nail images and reading out and displaying the information in the same manner as in the commercial information. In the same method, the commercial information includes at least one of a still picture, an animation and voice. The animation includes video information, and the voice includes music information. In this information management method, the commercial information includes at least one of network registration and contract information, various contracts information, current affairs information, bicycle race and horse race information, cooking information, fortune-telling information, calendar information, website information, guide information, sales information and rental information. The above guide information includes sight-seeing guide, shopping guide, book guide, education guide, employment guide, housing guide, event guide, marriage guide and fashion guide.

The information processing system of the present invention includes a network, capable of processing information comprising images, voice and documents in large volumes at high speeds, and comprises a removable storage medium having a storage section including a program storage area storing programs and an information storage area storing information, and an electronic circuit section mounting electronic circuits for processing information; and a device on the network dismountably mounting the storage medium; the device and the electronic circuit cooperating with each other when the storage medium is inserted; display means selectively displaying a header thumb-nail image corresponding to commercial information such as images, music, voice and documents stored by the storage medium in the information storage area thereof by operating a program stored by the storage medium in the program storage area thereof; and service starting means for calling and displaying of the corresponding commercial information, and/or purchase of information corresponding to the commercial information, and/or connection to, or registration of, a service provider on the network corresponding to the commercial information, in accordance with selection and instruction of a desired thumb-nail image by an operator.

The removable storage medium of the present invention has a storage section comprising a program storage area storing programs and an information storage area storing information, and an electric circuit section mounting electronic circuits processing information, storing:
commercial information such as images, music, voice and documents, and thumb-nail information corresponding to the commercial information in the information storage area; and a program storage area, storing:
a first program module which selectively displays a header thumb-nail image corresponding to the commercial information such as images, music, voice and documents stored by the storage medium in the information storage area thereof, through operation of a program stored by the storage medium in the program storage area thereof by cooperation of an external device and the electronic circuits; and a second program module for calling and displaying of commercial information, and/or purchase of information corresponding to the commercial information, and/or connection to, or registration of, a service provider on the network corresponding to the commercial information, in accordance with selection and instruction of a thumb-nail image desired by the operator.

The aforementioned storage medium of the invention is an optical disk, and the storage medium is on one surface, and the electronic circuit section is on the other surface.

The other objects of the present invention will become apparent from the following drawings and the following description in detail.

### BRIEF DESCRIPTION OF THE DRAWINGS

FIG. 1 is a block diagram illustrating a typical configuration of an ID and an external device of the information processing system of this embodiment of the present invention;

FIG. 2 shows an example data storage format of the storage section of the ID in this embodiment of the invention;

FIG. 3 is a flowchart of initial control in this embodiment;

FIG. 4 is a conceptual view of an example of configuration of storage on an information recording surface in this embodiment;

FIGS. 5 to 8 illustrate an example of display of the computer when “Net” is selected in the information processing system in this embodiment;

FIGS. 9 and 10 illustrate an example of display of the computer when “Home Page” is selected in the information processing system in this embodiment;

FIGS. 11 and 12 illustrate an example of display of the computer when “Goods” is selected in the information processing system in this embodiment;

FIGS. 13 to 15 illustrate an example of display of the computer when “DigiCam” (™) is selected in the information processing system in this embodiment;

FIG. 16 illustrates an example of display of the computer when “MP3” is selected in the information processing system in this embodiment;

FIGS. 17 and 18 illustrate an example of display of the computer when “Movie” is selected in the information processing system in this embodiment; and

FIGS. 19 and 20 are flowcharts showing the operating procedure of the information processing system in this embodiment.

### DETAILED DESCRIPTION OF THE PREFERRED EMBODIMENTS

To explain the present invention more in detail, embodiments of the invention will now be described with reference to the attached drawings.

<Storage Medium Having Electronic Circuits Forming the Information Processing System of this Embodiment and an External Device>

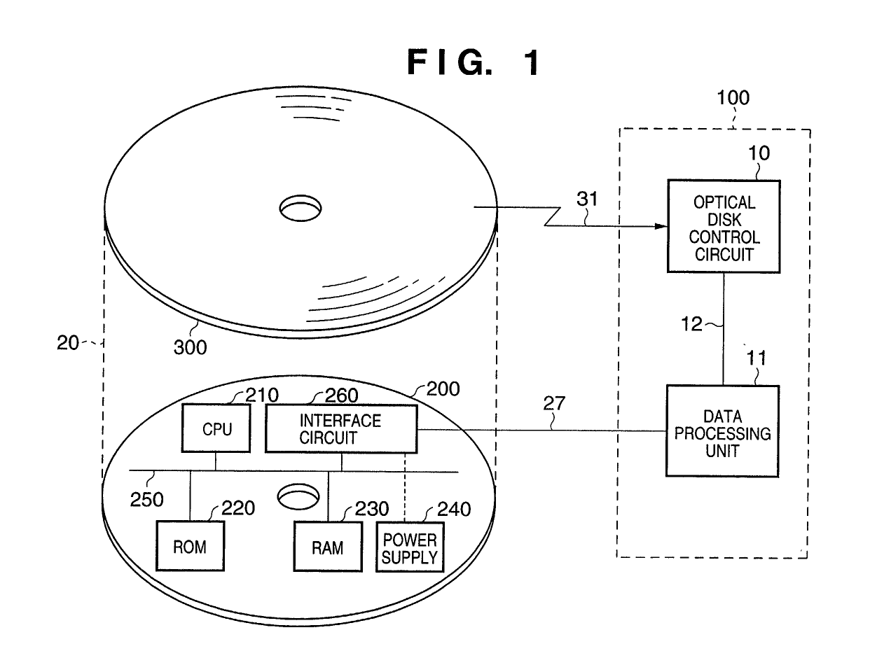

FIG. 1 illustrates a typical configuration of an ID (intelligent disk) used in this embodiment.

As shown in FIG. 1, the ID 20 comprises an electronic circuit mounting surface 200 and an information recording surface 300. In this embodiment, a CPU 210, an ROM 220, an RAM 230 and an interface circuit 260 are mounted on the electronic circuit mounting surface 200 to form a control section so as to be connected with a bus 250, and in addition, a power supply 240 for these components is mounted to supply electricity to the electronic circuits.

(Electronic Circuits)

The electronic circuits mounted on the electronic circuit mounting surface are shown in FIG. 1 as being provided functionally with individual parts and devices mounted thereon. The electronic devices may however be mounted on an insulated substrate such as a printed board or a ceramic board. A circuit maybe a combination of logic devices, or may comprise gate arrays, one-chips or SOCs (system-on-chip). This may be prepared by forming semiconductor circuits on a silicon substrate, a ceramic substrate, or an insulated substrate. They may also be laminated to form circuits.

The mounting position of the electronic circuits should preferably be at the center portion with a view to stabilizing the interface and the disk. It may be at any other position so far as the disk stability is ensured.

(Power Supply)

In FIG. 1, the power supply 240 may be a battery generating power by a chemical process or an air battery, or may be of a type receiving energy from outside. When energy is received from the outside, it may be received directly by a contact, or the power supply may receive energy by a light beam, radio or induction. Combinations of these are also conceivable. Furthermore, the type of transmitting and receiving through superposition of signals and the power supply may be adopted. The power supply 240 is used, not only to supply power to the electronic circuits mounted on the electronic circuit mounting surface 200, but also, when the above-mentioned ID 20 serves as a main control for an external system, may be used as a power supply for the external system. In this case, the ID 20 can play the role of the “attestation card” which permits use of the external system. When the power supply is fed from the system main body, on the contrary, it is not necessary to provide a power supply 240 on the ID 20.

(Interface)

In FIG. 1, 27 represents a communication path for achieving communication between the control section and a data processing unit 11 of the external circuit 100 via an interface circuit 260 of the control section mounted on the electronic circuit mounting surface, which is an interface signal line connecting the interface circuit 260 and the data processing unit 11. The interface signal line 27 may be, in practice, signals from the bus 250, or bus 250 transformed, converted, amplified or modulated. It may of course be parallel-series-converted (parallel/serial conversion) for serial communication, or super-parallel (the communication path has a larger bit width than that of the bus) or added with an error correcting symbol. For the interface signal line 270, conditions including electric connecting conditions such as an electric signal and timing in the aspect of hardware, mechanical or configurational connecting conditions, processing conditions in the aspect of software, method and protocol should preferably be standardized. As the interface signal line, a contact-type one and a non-contact type one are conceivable. Particularly in this embodiment, write-read of the information recording surface 300 is conducted optically. Adoption of a non-contact type optical interface is considered technically favorable.

(Information Recording Surface)

The information recording surface 300 in FIG. 1 stores the information of the ID 20 in this embodiment, which is, for example, a single side surface of an optical disk. The information stored in the information recording surface 300 may be in the form of bits as in an ordinary optical disk, or a magneto-optical disk, or may, of course, be stored by changing the recording color pigment. The information stored in the optical disk is read out as a readout signal 31 by the optical disk controller 10. When an optical disk such as an ordinary CD, an MO or DVD is inserted, read/write can be performed in the same manner as in an ordinary optical disk.

Also in FIG. 1, 31 represents an example in which the optical disk controller 10 optically reads out information from the information recording surface 300 of the ID 20; 12 represents a signal line which transfers the information recorded on the information recording surface 300, read out by the optical disk control circuit 10 to the data processing unit 11. This may be via the bus signal line of the data processing unit 11 or an input/output bus.

The external circuit 100 is shown with a simple configuration. The data processing unit 11 may be a general-purpose computer, or a special circuit. In the case of a general-purpose computer, the external circuit 100 may have the connecting function to the internet, and in the case of a special circuit, the electronic circuit may have the connecting function to internet. In this case, there would be provided a communication circuit permitting telephone communication directly with the outside.

The above description has covered the ID having the electronic circuit mounting surface 200 and the information recording surface 300 on the sides thereof. The storage capacity can be increased by adopting a three-layer configuration comprising an electronic circuit mounting surface 200 as an inner layer and information recording surfaces 300 on the both sides.

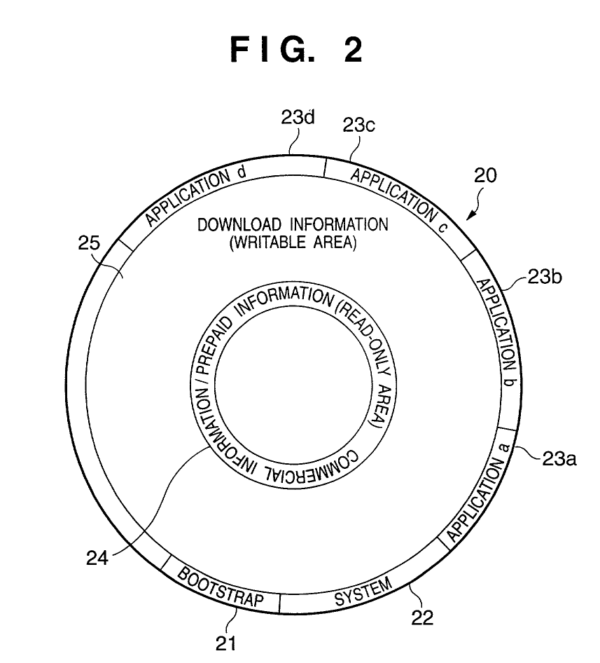

An example of storage format of the storage section of the ID of this embodiment is illustrated in FIG. 2.

In FIG. 2, 20 represents an ID. FIG. 2 is a schematic view of the ID 20 as viewed from the storage surface: 21 represents a bootstrap program storage area; 22, a system program storage area; and 23a to 23d, storage areas of packaged application programs a to d.

When using the storage surface as a partial CD, it comprises a read-only storage area 24 storing prepaid information and commercial information (including thumb-nail images), and a writable area 25 storing download information and user-prepared information. Depending upon whether fixed or changeable, the program area may be divided into a read-only area and a writable area. The layout of the read-only area and the writable area shown in FIG. 2 is only an example, and the layout of storage areas is not limited to that shown in FIG. 2. The fixed environmental information includes information prepared as services and information provided for customers purchasing the storage area. That is, the storage medium of the invention serves as a medium having functions of advertisements in brochures, PR catalogs, newspapers and magazines.

The programs stored in the bootstrap storage area 21 and the system program storage area 22 have contents varying with the environment provided by the system main body shown in FIG. 1. When the system main body has no OS, for example, an OS would be stored in the system program storage area 22. On the other hand, when the system main body has an OS, the system program storage area 22 suffices to store only a main control program regarding the information management according to the invention.

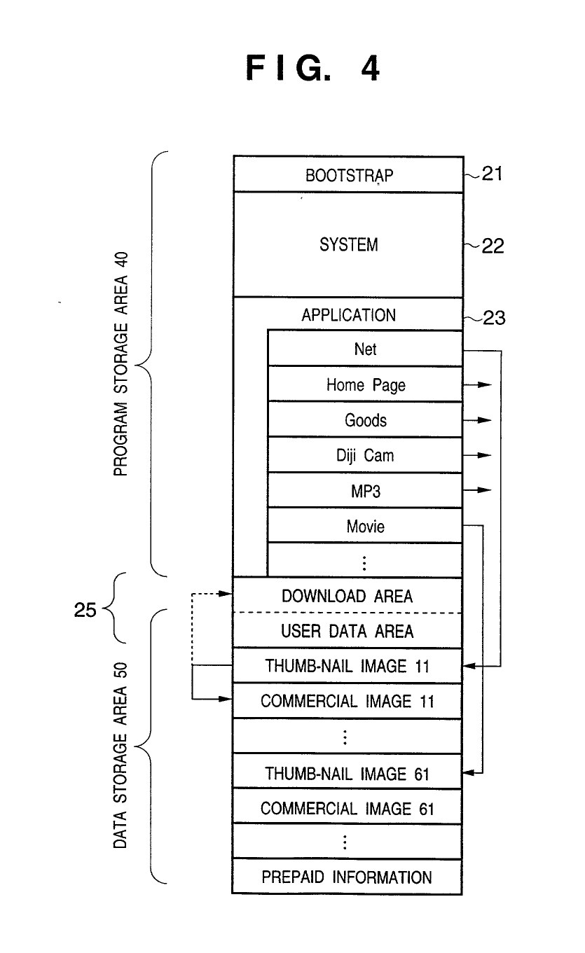

FIG. 4 is a schematic view of an outline of programs or information stored in the storage section of this ID and the relationship between them.

In FIG. 4, the storage areas of the storage section are broadly classified into a program storage area 40 and a data storage area 50. The program storage area 40 has a bootstrap program area 21, a system program area 22, and an application program area 23, and the application program area contains a “Net” processing application, a “Home Page” processing application, a “Goods” processing application, a “DigiCam” processing application, a “MP3” processing application, and a “Movie” processing application. In addition, this area may contain various contract information, stock market information, current affairs information, cycle race and horse race information, cooking information, fortune-telling information, calendar information, home page information, guide information, sales information, rental information, and guide information such as sight-seeing guide, shopping guide, book guide, education guide, employment guide, housing guide, event guide, marriage guide and fashion guide. From these pieces of information, selection and combinations are made in response to the taste and choice of clients and users. Or, many kinds of information may be grouped into a hierarchy (tree structure) so as to permit sequential searching of information.

One or more sets of thumb-nail images and commercial information read out from such thumb-nail images corresponding to the above processing applications are stored in the data storage area 50. The commercial information is prepared from still images, animations, voice, music and combinations thereof. Prepaid information may be contained in the data storage area 50.

Apart from the above-mentioned area not permitting rewrite by the user, there is available a storage area 25 permitting rewrite by the user. This area contains, via internet or the like, a download area in which programs, data or commercial information are downloaded, and a user data area storing information prepared by the user such as DigiCam information.

Although a detailed description is omitted here, the hardware of the information processing system of this embodiment and the software for information processing or the software for data processing should preferably have the following functions:

### EXAMPLE OF FUNCTIONAL SPECIFICATIONS

Selection within a covered range is performed with a mouse (selection of outline of article)
Resolution: at least 75 dpi
Number of colors: at least 256
Corresponding formats:
   Read: JPG, BMP, PIC, TIF, GIF
   Write: JPG, BMP
Other functions
   Color changing function
   Contrast changing function
   Clearness changing function
   Sharpness changing function
   □ Square selecting function: adjustable range
   ⋆ Free selection function: adjustable range
   Deformation: Image size changing function: Simple enlargement, contraction, Expansion and contraction without changing resolution: −20 to 800%

To achieve these functions, for example, an internet connecting program, a thumb-nail image preparing program, a thumb-nail image management program, a commercial information management program, an image display program, an animation display program, a data input/output program, a data storing program, an image/voice processing program, a data transmitting/receiving program, a data converting program, a user identifying program, an accounting program and the like are stored in the system program storage area 22 or in the application program storage area 23. Parameters used in the above programs, commercial information, thumb-nail image information, and user management information are stored in the data area 24 or 25. The data area, having a large capacity, can store downloaded animations. However, when the data area has only a small capacity, this ID may be used only for information management, and the information main body may be stored in another medium to share functions.

Examples of operation based on the cooperation between the electronic circuits of the ID in an embodiment of the invention and an external device will now be described. The following description will cover a case where there are provided registration in network (main menu “Net”), selection of, and connection to, a home page (main menu “Home Page”), commercial and order of goods (main menu “Goods”), management of DegiCam images (main menu “DigiCam”), commercial and order of music/voice (main menu “MP3”), and commercial and order of movies and video (main menu “Movie”). However, a registration and contract information for other network, information about various contracts, stock dealing information, current affairs information, cycle race and horse race information, cooking information, fortune telling information calendar information, home page information, sales information and rental information may be contained, and a sight-seeing guide, a shopping guide, a book guide, an education guide, an employment guide, a housing guide, an event guide, a marriage guide and fashion guide may be included in the guide information. The kind, the number and the priority of these pieces of information in selecting any of them may vary with the bracket to which this ID is to be sold. When the increase in the number of menus causes complexity, it is conceivable to deepen the hierarchy by grouping them.

Share of information processing between the electronic circuits of ID and the external device may be any of many combinations ranging from a system based on an external device in which the external device executes the OS and the like, to a system led by the ID in which the electronic circuits execute the OS and the like. Therefore, the work is shared between the electronic circuits of ID and the external device for each processing module or for each step in response to the share of information processing.

### EXAMPLE OF STARTUP PROCEDURE BY ID OF INFORMATION PROCESSING SYSTEM

1. Inserting the ID, causing automatic startup (boots, system) and displaying the menu.

2. Using the browser for display of the main menu; contents of menu: “Net”, “Home Page”, “Goods”, “DigiCam”, “MP3” and “Move”.

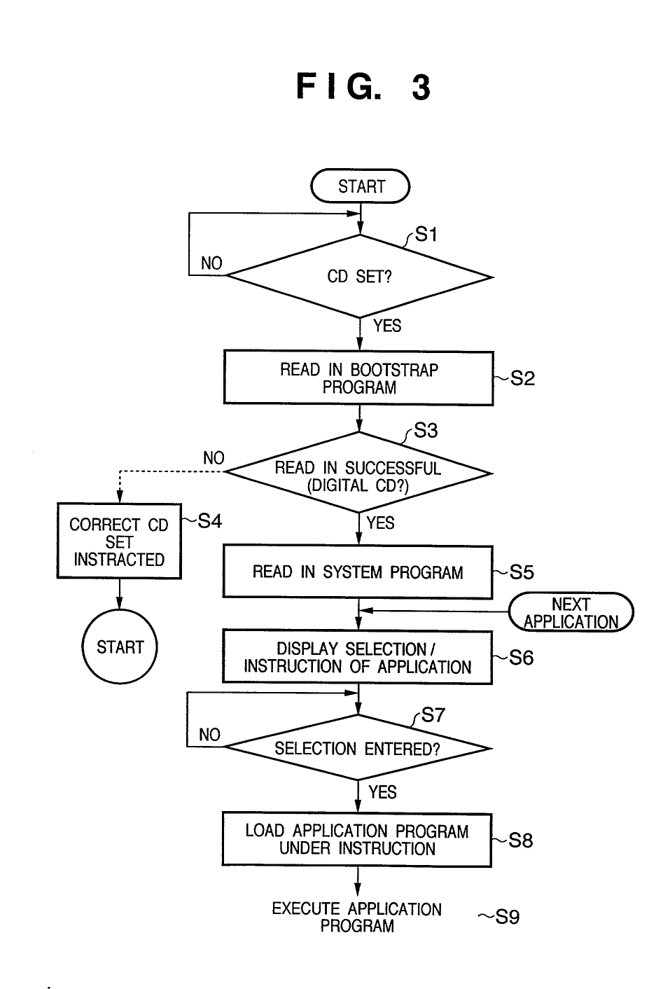

An example of procedure from insertion or installation of the ID to the manu display will now be described with reference to the flowchart shown in FIG. 3.

When turning on the power supply of the apparatus shown in FIG. 1, and when the system reset switch 8 is pressed down, or when the apparatus OS is already in operation, the initial control shown in the flowchart of FIG. 3 is executed upon insertion or installation of the ID into the drive.

First, setting of the ID into the ID apparatus is monitored in step S1. Upon setting of the ID, the process proceeds to step S2, and the CPU 1 accesses the least program incorporated in the ROM 2 or the bootstrap program storage area 21 in the ID in accordance with the apparatus OS to reads in the bootstrap program.

In the following step S3, it is checked whether or not the bootstrap program has been read in. If not, the process returns back to step S1, or, as shown in FIG. 3, turns on an indicator informing “loading not allowed” or not “ID” not shown, attached to CRT 6 or the outer side of the apparatus to notify the operator (step S4).

When read of the bootstrap program is successful in step S3, and the set ID is the ID, the system program (the system program includes, for example, the operating system (OS)) is read in by use of the bootstrap program just read in step S5. Subsequently, processing is performed in accordance with the system program thus read in.

For example, in step S6, a selection screen of currently selectible and executable application programs is displayed on the CRT 6; in step S7, selection and input are waited for; upon selection and input, in step S8, a corresponding application program is read in from the ID apparatus; as shown in step S9, processing is carried out in accordance with the read-out application program.

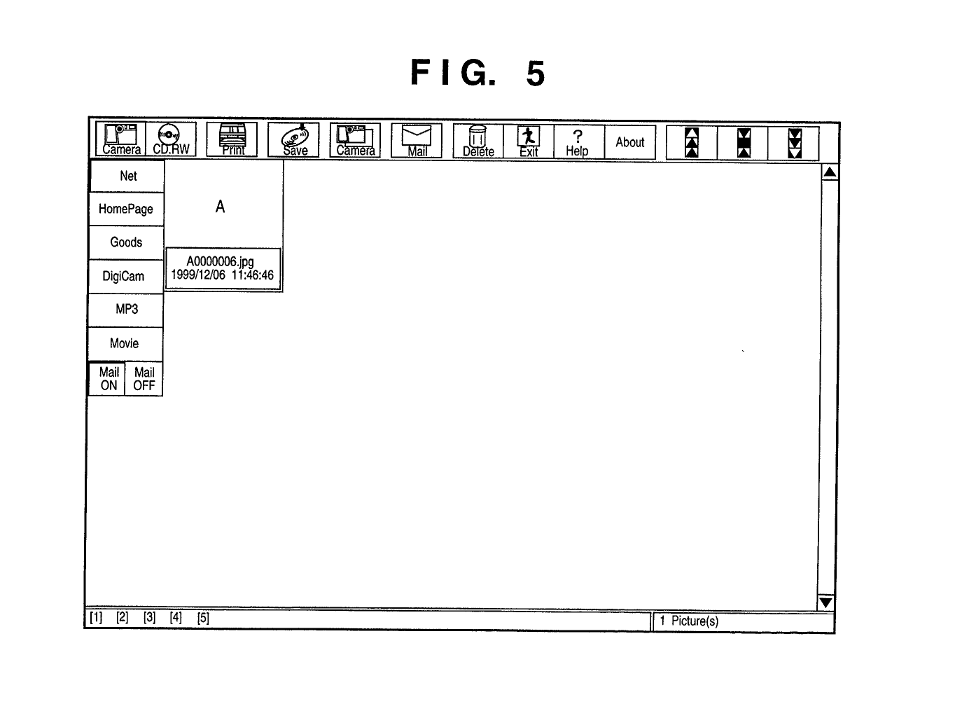

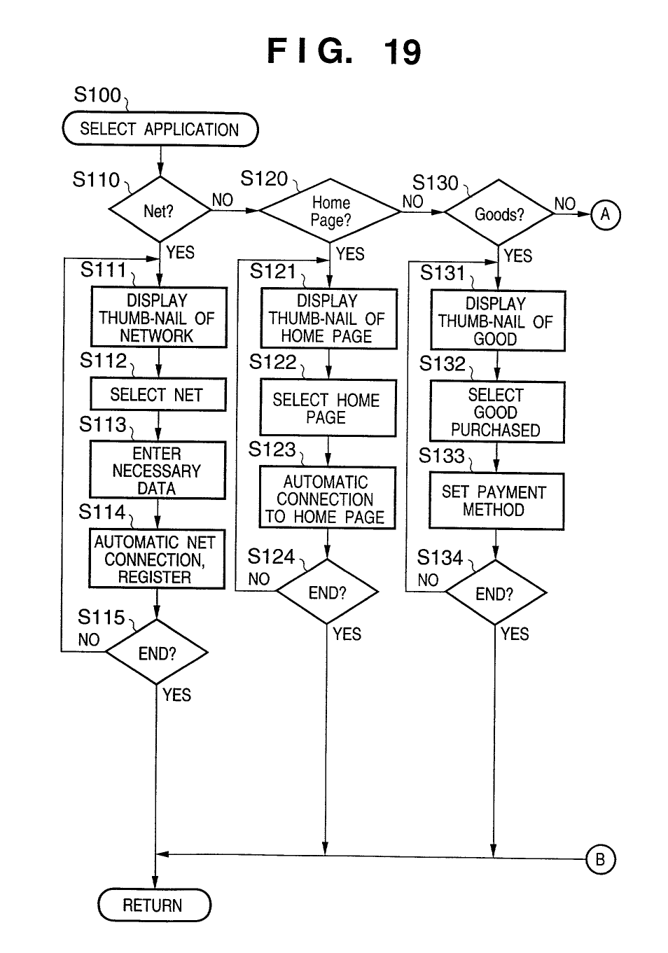

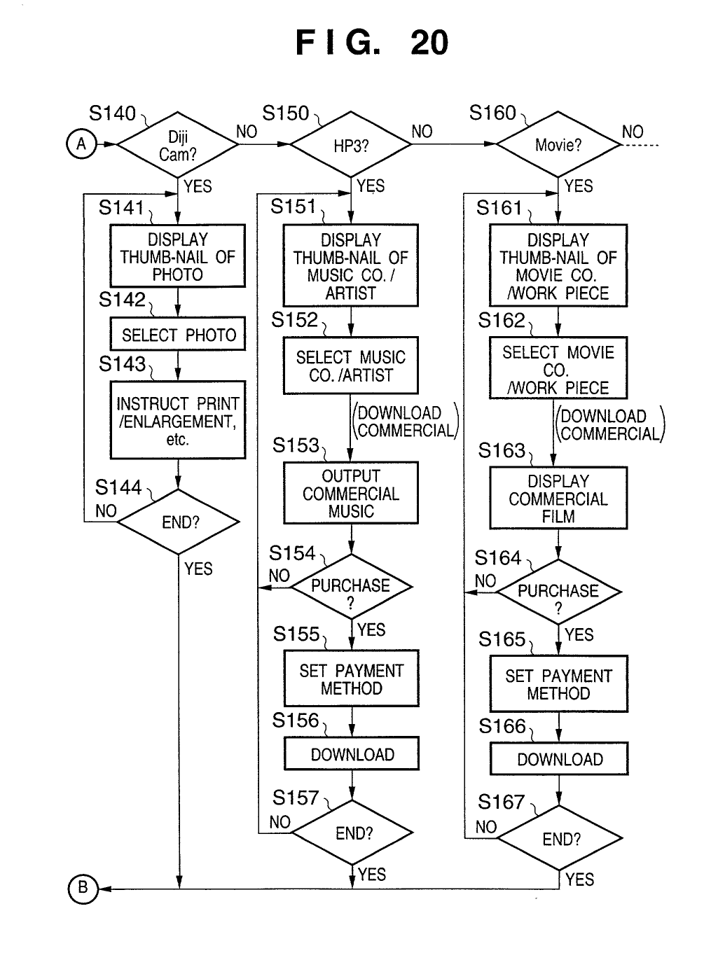

An example of selection screen of application, an example of display of a thumb-nail image upon selection of the above-mentioned main menus, and commercial information when one of the thumb-nail image is selected are shown in FIGS. 5 to 18. The operating procedure for achieving these operations is schematically shown in the flowcharts of FIGS. 19 and 20.

### EXAMPLE OF OPERATING PROCEDURE OF INFORMATION PROCESSING SYSTEM

An example of operating procedure of the information processing system will sequentially be described with reference to FIGS. 5 to 20. The advantages of the invention do not vary as a result of a change in the order of steps.

First, in step S100 shown in FIG. 19, one application is selected from the main menus “Net”, “Home Page”, “Goods”, “DigiCam”, “MP3”, and “Movie”.

(Net Processing)

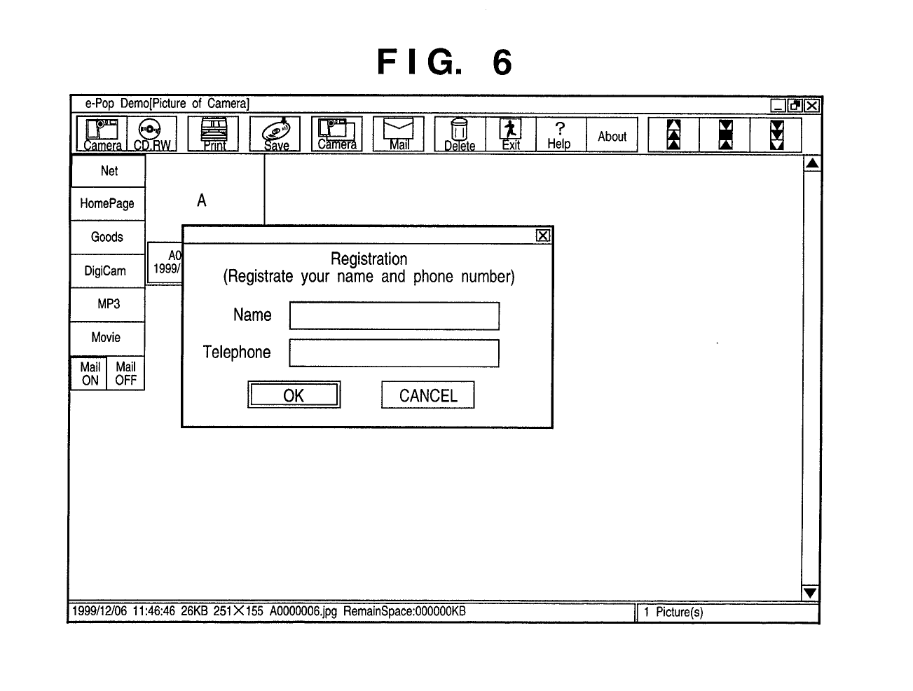

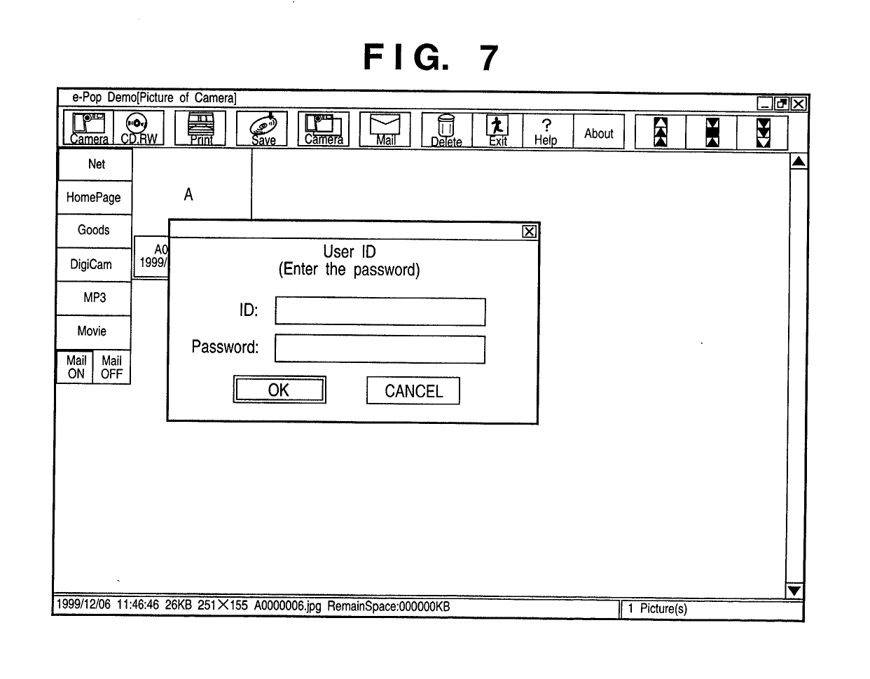

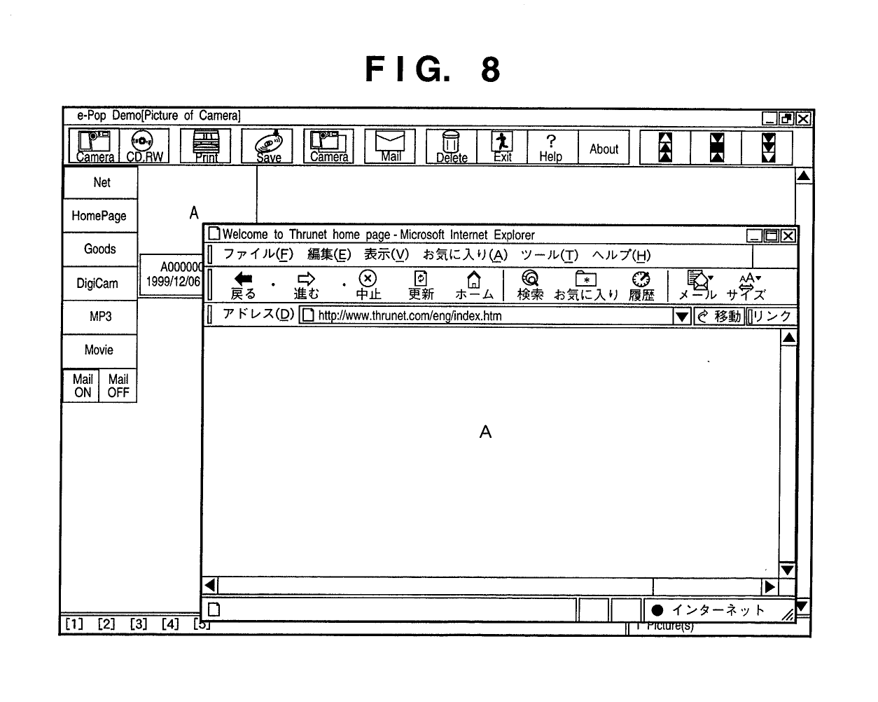

When “Net” is selected, the process goes from step S110 to S111, and a thumb-nail image showing the kind of network is displayed as shown in FIG. 5. While FIG. 5 shows only one network “A”, a plurality of networks may be displayed. Then, in step S112, the user selects a desired network by clicking the mouse. Then, in step S113, as shown in FIGS. 6 and 7, a name or a telephone number, or a user ID or a password is entered. Upon the completion of this input, in step S114, connection is automatically made to the network “A” in this embodiment and registration is conducted, and a display as shown in FIG. 8 is shown. This image is registered as a thumb-nail image as one of “Home Pages” explained in the following paragraph. Instep S115, it is determined whether end or not of the “Net” processing application. If not, the process returns back to step S111 to display the thumb-nail again to wait for the next input.

(Home Page Processing)

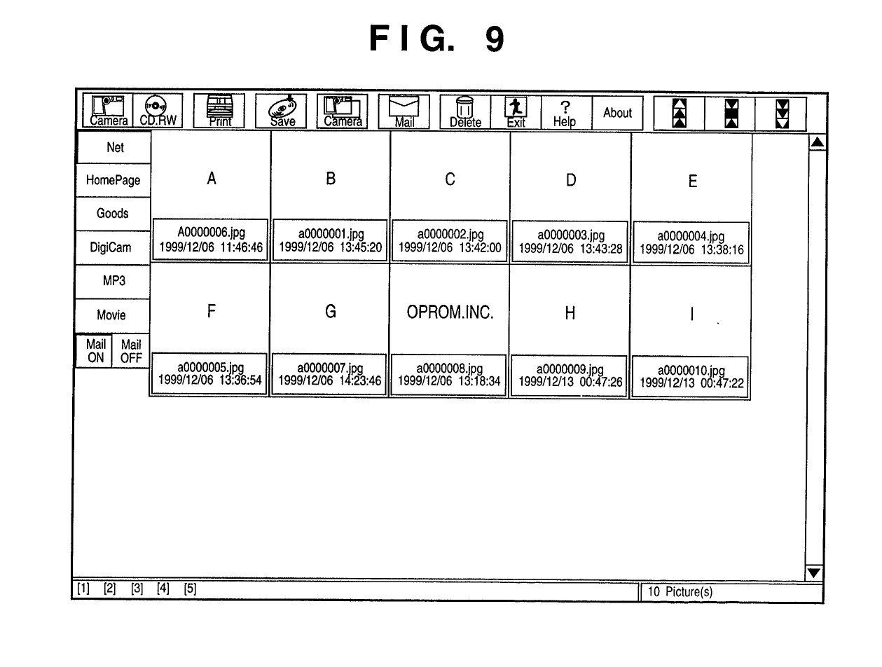

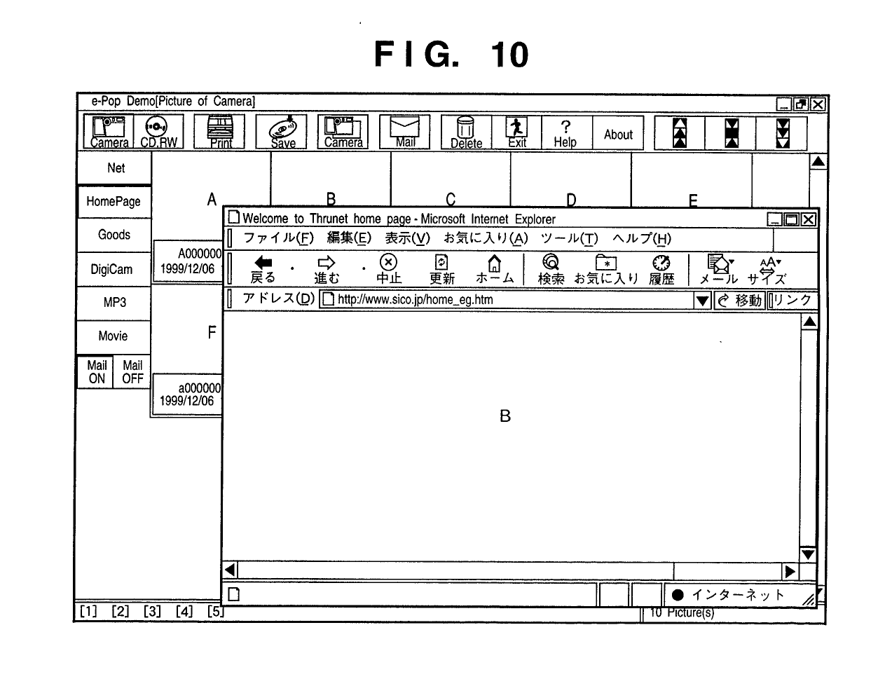

When “Home Page” is selected, the process moves from step S120 to S121, and as shown in FIG. 9, thumb-nail images showing home pages are displayed. FIG. 9 illustrates thumb-nail images for ten home pages are displayed. Then, when the user selects a desired home page (for example, B) in step S122 by clicking the mouse, the user is automatically connected to the selected home page in step S123, as shown in FIG. 10. In step S124, it is determined whether end or not of the “Home Page” processing application. If not, the process returns back to step S121, and the thumb-nail is displayed again to wait for the next input.

(Goods Processing)

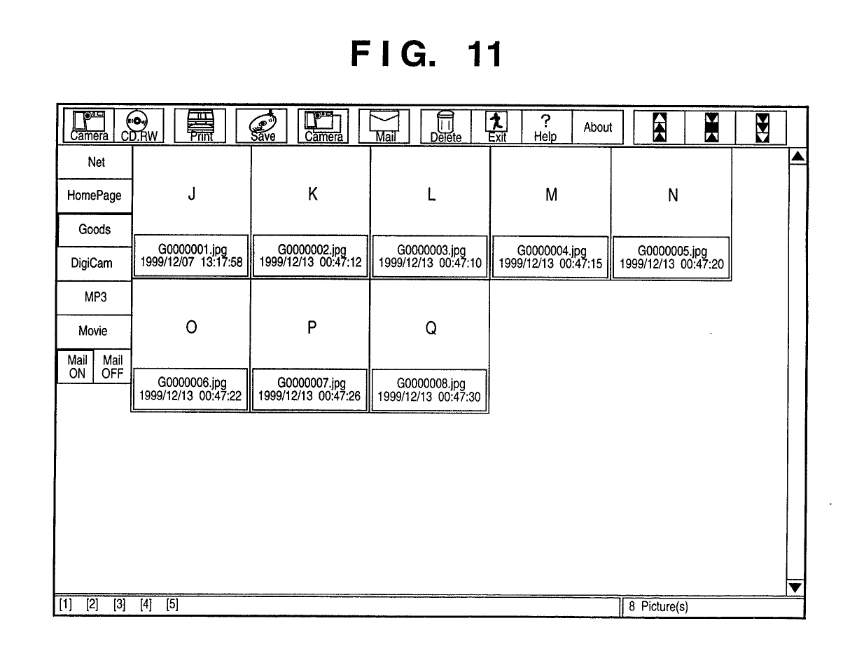

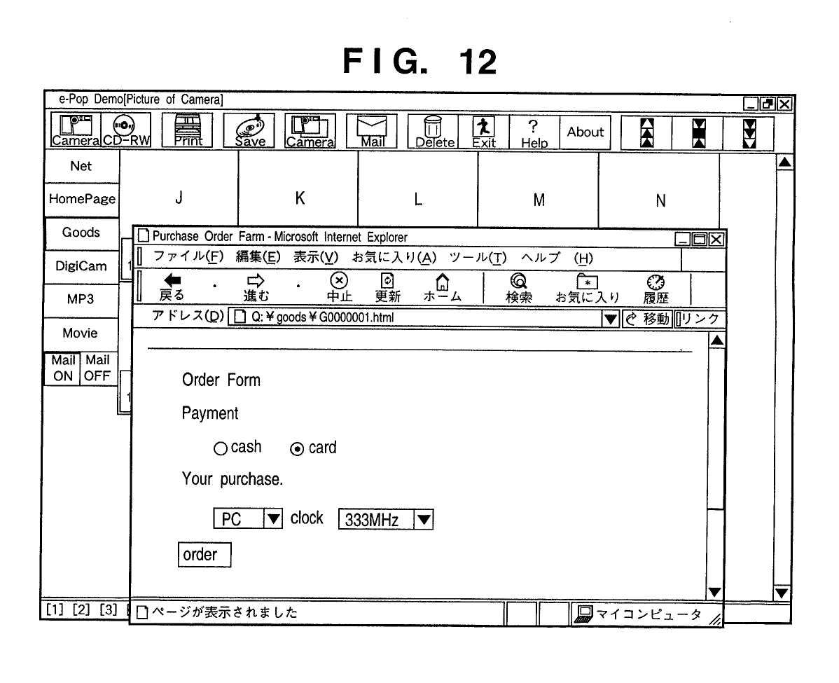

When “Goods” is selected, the process proceeds from step S130 to S131, and as shown in FIG. 11, thumb-nail images showing the kind of products to be sold are displayed. FIG. 11 shows J to Q. The thumb-nail images displayed in this step however include marks and trademarks of the maker or the securities companies, and other items regarding sales, such as tickets for theatrical performances and movies, and reservation of airplanes and trains. Then, in step S132, upon user's selection of a desired goods to be purchased by clicking the mouse, a method of sale is set and an order is established in step S133 as shown in FIG. 12. In this case, it is needless to mention that the user equipment and the user are identified. The prepaid information stored in the prepaid information area may be used. In step S134, it is determined whether end or not of the “Goods” processing application. If not, the process goes back to step S131, and the thumb-nail images are displayed again to wait for the next input.

(DigiCam Processing)

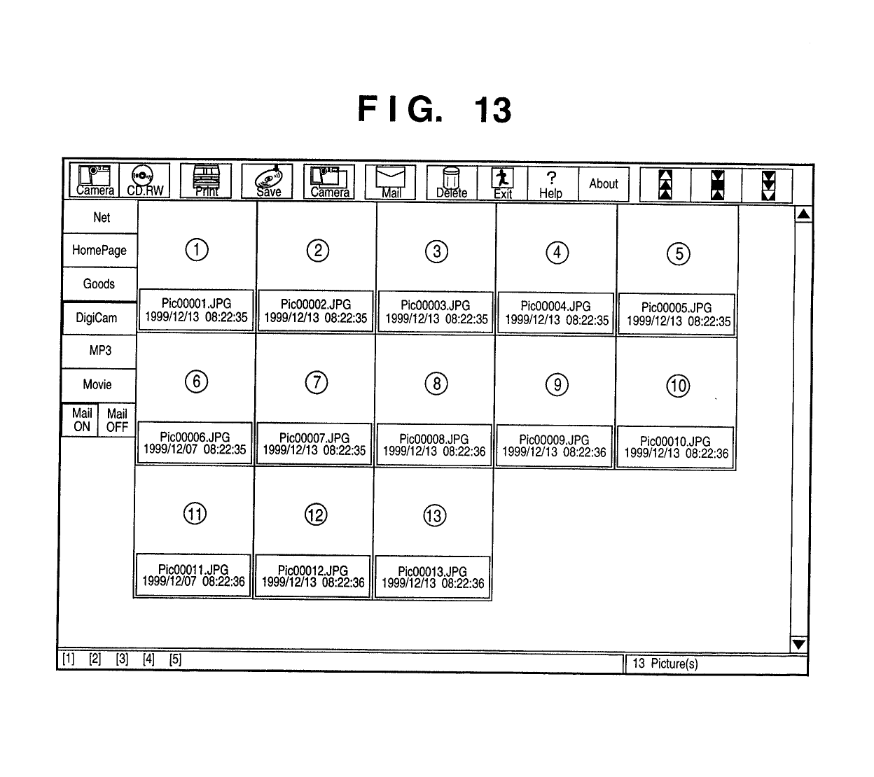

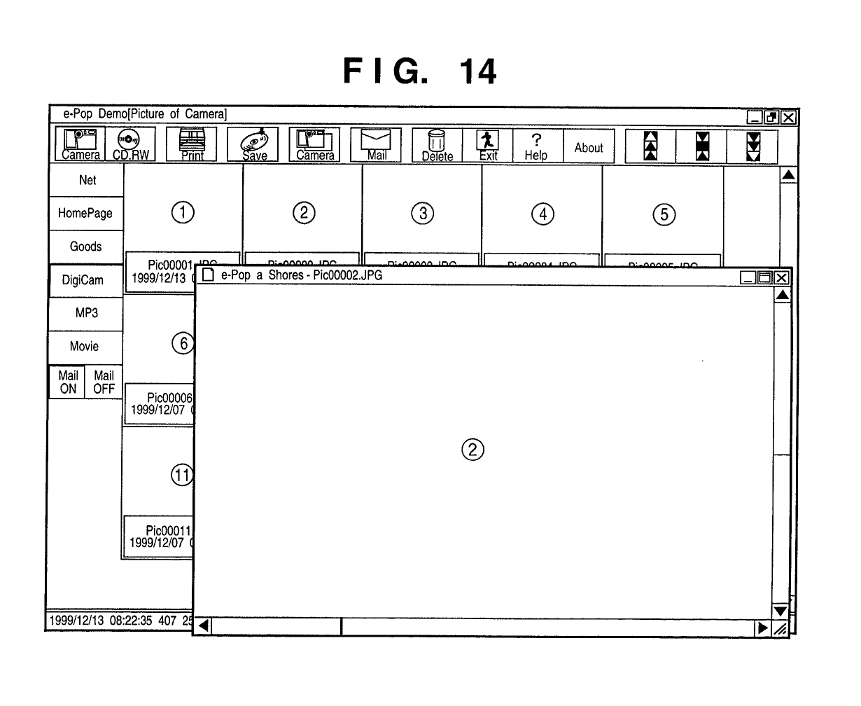

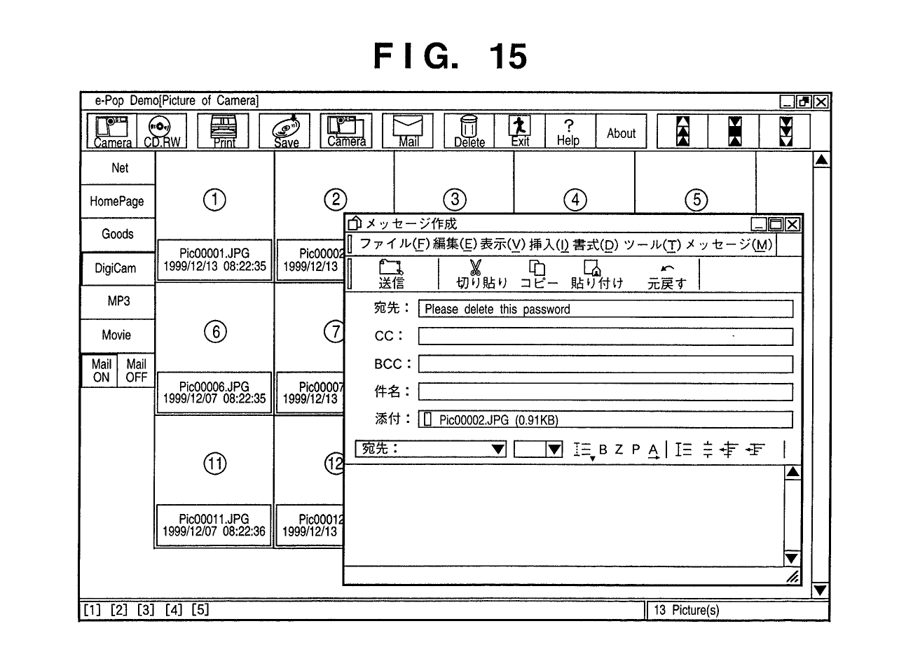

When “DigiCam” is selected, the process goes from step S140 to S141, and as shown in FIG. 13, thumb-nail images showing a digital camera pictures. While 13 thumb-nail images are displayed in FIG. 13, images exceeding 15 are displayed in page 2 and subsequent pages, and scrolling to the preceding or following page. Then, in step S142, user selects a desired picture by clicking the mouse. In step S143, the image clicked is displayed in an enlarged size, or the picture is printed on a printer as shown in FIG. 14, or processing such as editing is executed as shown in FIG. 15.

The lower-level processing of the “DigiCam” processing will briefly shown below:
Image
   Display of an image data list
   Selection of image data on ID
   Read of image data on ID
   Startup of retouch software
   Image data retention is stored in JPEG and BMP formats
Image printing
   Selection and printing of image
   Special printing (printing of multiple sheets)
Digital camera
   Read and display of image
   Selection and retention of image
File editing
   Retrieval, display, reproduction
   Copying, transfer, deletion, synthesis, retention
Automatic retention of file
Manual retention of file
   Change of file name
   Specification of place of retention
   Input of comments

In step S144, it is determined whether end or not of the “DigiCam” processing application. If not, the process goes back to step S141, and the thumb-nail image is displayed again to wait for the next input.

(MP3 Processing)

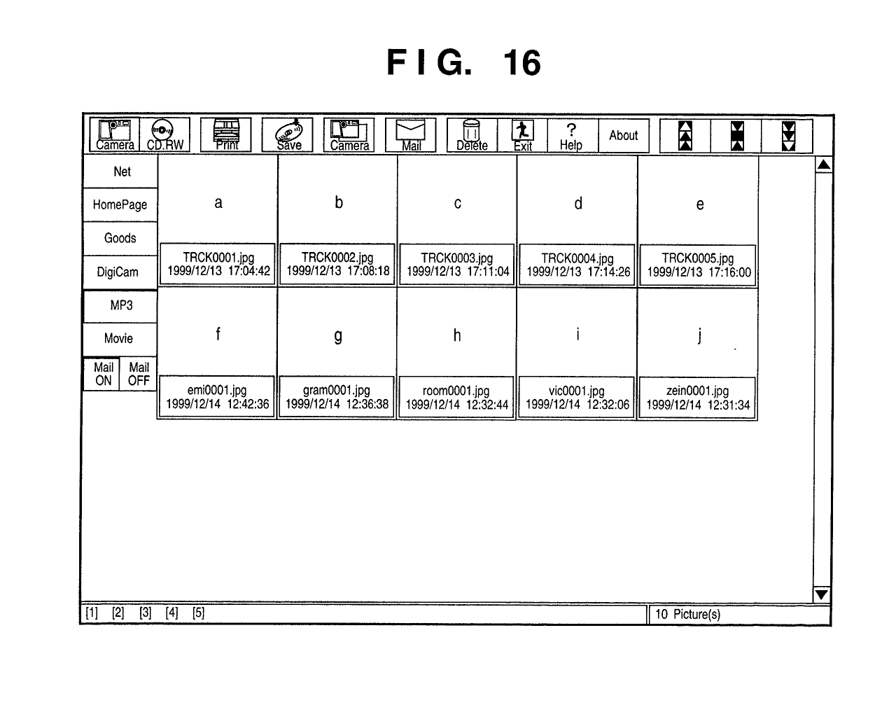

When “MP3” is selected, the process proceeds from step S150 to S151, and thumb-nail images representing companies or artists supplying voice and music are displayed in spaces a to j in FIG. 16. Then, in step S152, the user selects a desired company or artist by clicking the mouse. Upon this input, a commercial of new musics or a part of reading aloud is output in step S153. The user selects whether purchase or not in step S154. If not, the process returns back to step S151, and the thumb-nail image is displayed again to wait for the next input. When purchasing, the process goes to step S155, and a method of payment of the proceeds is set. After attestation of setting, the contents are downloaded via internet in step S156. The thumb-nail image is registered so as to be capable of subsequent selection. In step S157, it is determined whether end or not of the “MP3” processing application. If not, the process goes back to step S151, and the thumb-nail image is displayed again to wait for the next input.

(Movie Processing)

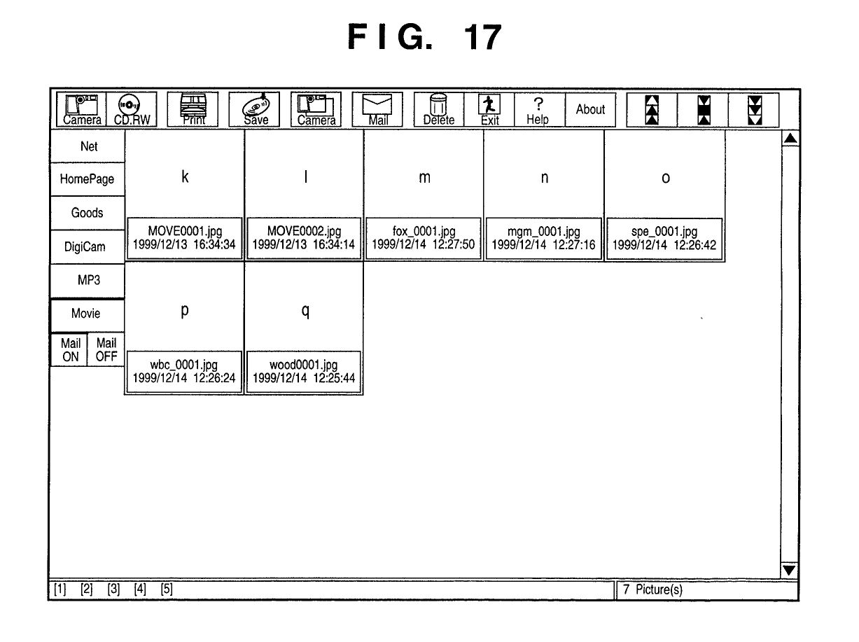

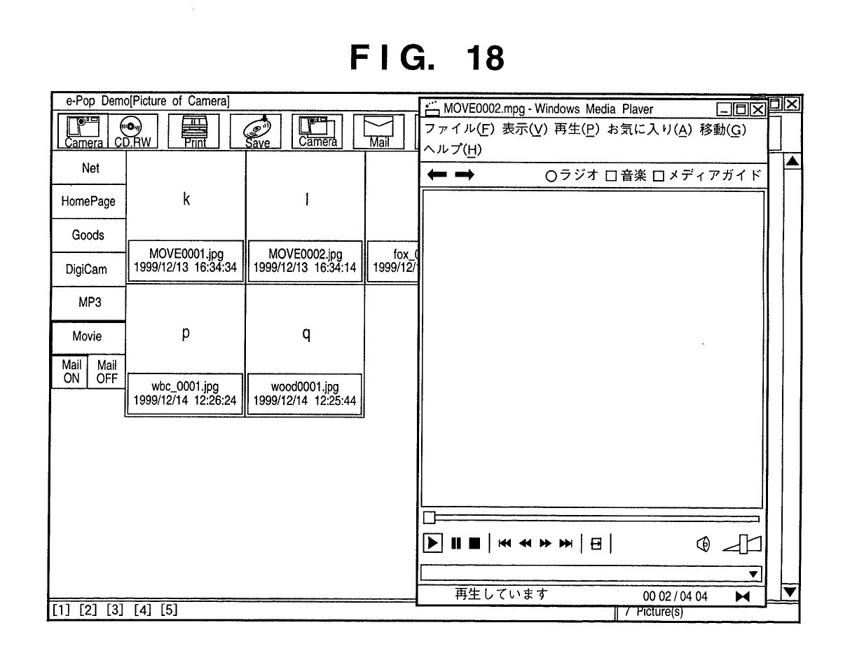

When “Movie” is selected, the process proceeds from step S160 to S161, and thumb-nail images representing the companies supplying movies and video or pieces of work are displayed in spaced k to q in FIG. 17. Then, in step S162, the user selects a desired company or piece of work by clicking the mouse in step S162, and in step S163, as shown in FIG. 18, a part of the image or the like is output as commercial information. In step S164, the user selects purchase or not. If not, the process returns back to step S161, and the thumb-nail images are displayed again to wait for the next input. If purchasing, the process proceeds to step S165, and a method of payment is set. Upon attestation of setting, the contents are downloaded via internet in step S166, and the thumb-nail image is registered to as to be capable of being selected subsequently. In step S167, it is determined whether end or not of the “Movie” processing application. If not, the process returns back to step S161, and the thumb-nail images are displayed again to wait for the next input.

The case of a general-purpose computer used as an external device has been described above. However, the present invention is characterized by the storage medium having electronic circuits, and mountable, not only to a special machine such as a cellular phone or an electronic notebook, a wired telephone set and a facsimile machine, but also to all home electrical appliances only if it is an information processing unit capable of mounting this storage medium.

According to the present invention, it is possible to provide a storage medium having electronic circuits which permits automatic startup of a system by insertion or installation of the storage medium having electronic circuits, and totally achieves commercial display of various services, internet services such as contract procedure, purchase of goods and guide and retrieval, and user information management, an information management method and an information processing system using such a storage medium.

The invention has described by means of the preferred embodiments. The invention is not however limited to the aforementioned embodiments, but various variants are possible within ranges set forth in claims.

1. An information management method in an information processing system including a network capable for dealing with information such as images, music, voice and documents in large volumes at high speeds, comprising the steps of:
when connecting a removable storage medium having a storage section including a program storage area storing programs and an information storage area storing information, and an electronic circuit section mounting electronic circuits processing information, to a device on the network,
selectively displaying header thumb-nail images corresponding to commercial information such as images, music, voice and documents stored by said storage medium in the information storage area thereof by operating programs stored by said storage medium in the program storage area thereof by cooperation of said device and the electronic circuits; and
calling and displaying of corresponding commercial information, and/or purchase of information corresponding to said commercial information, and/or purchase of information corresponding to said commercial information, and/or connection to, or registration of, a service provider on the network corresponding to said commercial information, in accordance with selection and instruction of thumb-nail images desired by the operator.

2. An information management method according to claim 1, wherein said method comprises, when purchasing information corresponding to said commercial information, downloading the purchased information into the information storage area of said storage medium, or permitting a commodity purchase procedure of the purchased information, and when downloading the purchased information in the information storage area of said storage medium, registering the header thumb-nail corresponding to said downloaded information in the information storage area of said storage medium.

3. An information management method according to claim 1, wherein said method comprises, when connecting to the service provider or registration thereof corresponding to said commercial information, downloading the commercial information of said service provider into the information storage area of said storage medium, and registering a header thumb-nail image corresponding to said commercial information in the information storage area of said storage medium.

4. An information management method according to claim 1, comprising the steps of further storing information prepared by the operator such as images, music, voice and documents in the information storage area of said storage medium, selectively displaying header thumb-nail images, and reading out and displaying said information in the same manner as in said commercial information.

5. An information management method according to claim 1, wherein said commercial information includes at least one of a still picture, an animation and voice.

6. An information management method according to claim 5, wherein said animation includes video information, and said voice includes music information.

7. An information management method according to claim 1, wherein said commercial information includes at least one of network registration and contract information, various contracts information, current affairs information, bicycle race and horse race information, cooking information, fortune-telling information, calendar information, home page information, guide information, sales information and rental information.

8. An information management method according to claim 7, wherein said guide information includes sight-seeing guide, shopping guide, book guide, education guide, employment guide, housing guide, event guide, marriage guide and fashion guide.

9. An information processing system including a network, capable of processing information of images, voice and documents in large volumes at high speeds, comprising:
a removable storage medium having a storage section including a program storage area storing programs and an information storage area storing information, and an electronic circuit section mounting electronic circuits for processing information; and a device on the network dismountably mounting said storage medium;
wherein said device and said electronic circuit cooperating with each other when said storage medium is inserted;
display means selectively displaying a header thumb-nail image corresponding to commercial information such as images, music, voice and documents stored by said storage medium in the information storage area thereof by operating a program stored by said storage medium in the program storage area thereof; and
service starting means for calling and displaying of the corresponding commercial information, and/or purchase of information corresponding to said commercial information, and/or connection to, or registration of, a service provider on the network corresponding to said commercial information, in accordance with selection and instruction of a desired thumb-nail image by the operator.

10. An information processing system according to claim 9, wherein, when purchasing information corresponding to said commercial information, said system further comprises:
means for taking commodity purchasing procedure of information to be purchased;
means for downloading the purchased information into the information storage area of said storage medium when the purchased information can be downloaded; and
means for registering the header thumb-nail image corresponding to said downloaded information in the information storage area of said storage medium when downloading the purchased information in the information storage area of said storage medium.

11. An information processing system according to claim 9, wherein, when connecting to, or registering, a service provider corresponding to said commercial information, said system further comprises:
means for downloading commercial information of said service provider onto the information storage area of said storage medium; and
means for registering the header thumb-nail image corresponding to said commercial information in the information storage area of said storage medium.

12. An information processing system according to claim 9, wherein said storage medium further stores information prepared by the operator such as images, music, voice and documents in the information storage area thereof;
said display means selectively displays the header thumb-nail image corresponding to said information; and
said service starting means reads out and displays said information like obtaining said commercial information in accordance with selection and instruction of the desired thumb-nail image by the operator.

13. A removable storage medium having a storage section comprising a program storage area storing programs and an information storage area storing information, and an electronic circuit section mounting electronic circuits processing information, storing:
commercial information such as images, music, voice and documents, and thumb-nail information corresponding to said commercial information in said information storage area; and
a first program module which selectively displays a header thumb-nail image corresponding to the commercial information such as images, music, voice and documents stored by said storage medium in the information storage area thereof, through operation of a program stored by said storage medium in the program storage area thereof by cooperation of an external device and the electronic circuits; and
a second program module for calling and displaying of commercial information, and/or purchase of information corresponding to said commercial information, and/or connection to, or registration of, a service provider on the network corresponding to said commercial information, in accordance with selection and instruction of a thumb-nail image desired by the operator,
in said program storage area.

14. A storage medium according to claim 13, wherein said second program module comprises, when information corresponding to said commercial information is purchased, the steps of downloading the purchased information in the information storage area of said storage medium, and registering a header thumb-nail image corresponding to said downloaded information in the information storage area of said storage medium.

15. A storage medium according to claim 13, wherein, when connection to, or registration of, a service provider corresponding to said commercial information has been done, said second program module comprises the steps of downloading the commercial information of said service provider in the information storage area of said storage medium, and registering a header thumb-nail image corresponding to said commercial information in the information storage area of said storage medium.

16. A storage medium according to claim 13, wherein the information storage area of said storage medium further stores information such as images, music, voice and documents prepared by an operator; and said first program module comprises the step of selectively displaying the header thumb-nail image corresponding to said information, and said second program module comprises the step of reading out and displaying said information like said commercial information in accordance with selection and instruction of a thumb-nail image desired by the operator.

17. A storage medium according to claim 13, wherein said storage medium has a special read-only area and a writable area.

18. A storage medium according to claim 13, wherein said program storage area further stores a bootstrap program and a system program which is read out by said bootstrap program and controls said first and second program modules.

19. A storage medium according to claim 13, wherein said storage medium is an optical disk, and said storage medium is on a side surface, and said electronic circuit section is on the other side surface.
